(19) United States
(12) Patent Application Publication
(10) Pub. No.: US 2026/0037815 A1
(43) Pub. Date: Feb. 5, 2026

(54) ELECTRIC VEHICLE CHARGE TIME PREDICTION

(71) Applicant: Rivian IP Holdings, LLC, Irvine, CA (US)

(72) Inventors: Sihang CHEN, Fremont, CA (US); Mohammed FARAG, Mountain View, CA (US)

(21) Appl. No.: 18/788,529

(22) Filed: Jul. 30, 2024

(51) Int. Cl. G06N 3/09; B60L 53/30; G06N 20/00

(52) U.S. Cl. CPC G06N 3/09; B60L 53/305; G06N 20/00; B60L 2240/545; B60L 2240/547; B60L 2240/549; B60L 2250/16; B60L 2260/46; B60L 2260/50

(57) ABSTRACT

Systems and methods for electric vehicle charge time prediction are provided. Embodiments include providing, as inputs to a machine learning model, one or more attributes of a battery of a vehicle and one or more attributes of a vehicle charger. Embodiments include receiving, from the machine learning model in response to the inputs, a set of incremental charge time predictions corresponding to a plurality of increments between a current charge level of the battery of the vehicle and a target charge level of the battery of the vehicle. Embodiments include providing via a user interface screen, based on the set of incremental charge time predictions, a charge time estimate for charging the battery of the vehicle using the vehicle charger.

### INTRODUCTION

The present disclosure relates to vehicles. More particularly, the present disclosure relates to predicting charge time for electric vehicles.

### SUMMARY

Embodiments of the present disclosure advantageously provide systems and methods for electric vehicle charge time prediction. In certain embodiments, a method for electric vehicle charge time prediction may include: providing, as inputs to a machine learning model, one or more attributes of a battery of a vehicle and one or more attributes of a vehicle charger; receiving, from the machine learning model in response to the inputs, a set of incremental charge time predictions corresponding to a plurality of increments between a current charge level of the battery of the vehicle and a target charge level of the battery of the vehicle; and providing via a user interface screen, based on the set of incremental charge time predictions, a charge time estimate for charging the battery of the vehicle using the vehicle charger.

### BRIEF DESCRIPTION OF THE DRAWINGS

FIG. 1A and FIG. 1B depict diagrams of an example vehicle, in accordance with embodiments of the present disclosure.

FIG. 2 presents a block diagram of example components of a vehicle, in accordance with embodiments of the present disclosure.

FIG. 3 presents a block diagram representing example functionality related to electric vehicle charge time prediction through machine learning, in accordance with embodiments of the present disclosure.

FIG. 4 presents a block diagram of example functionality related to training a machine learning model for electric vehicle charge time prediction, in accordance with embodiments of the present disclosure.

FIG. 5 depicts a flow chart representing functionality associated with electric vehicle charge time prediction, in accordance with embodiments of the present disclosure.

### DETAILED DESCRIPTION

Electric vehicles are powered by batteries that are regularly charged, such as via electric vehicle charging stations. Estimating the time that it will take to charge an electric vehicle's battery is useful for a variety of purposes, such as to determine when and where to charge the battery, how much time should be allocated for such charging in order to achieve a target amount of charge, and/or otherwise for planning purposes. Existing techniques for estimating a charge time for an electric vehicle generally involve a configured lookup table that stores associations between cell voltage under load and expected charge times, which may be based on pre-determined current profiles for different state of charge (SOC) values.

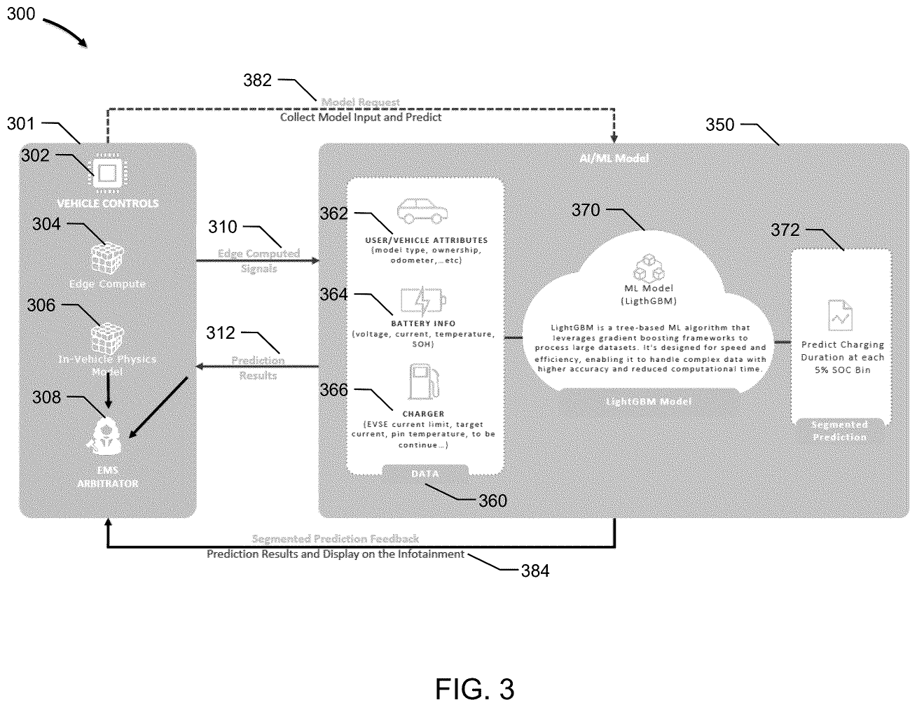

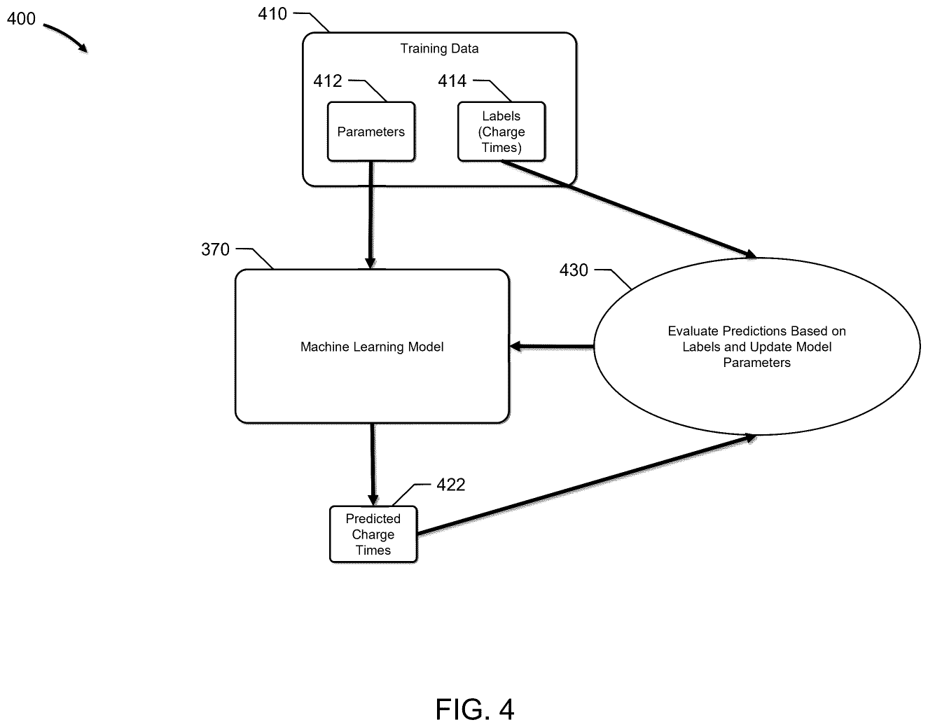

Aspects of the present disclosure provide improved electric vehicle charge time estimates through the use of a dynamic machine learning technique that is based on a variety of factors related to the vehicle battery and the vehicle charger and that generates incremental charge time predictions for improved accuracy and flexibility. For example, as described in more detail below with respect to FIG. 3, a machine learning model may be trained to output incremental charge time predictions (e.g., for each 5% increment between the current charge level and a target charge level such as a complete charge) in response to inputs that include vehicle battery attributes (e.g., present charge level, voltage, current, temperature, state of health, and/or the like), vehicle charger attributes (e.g., current limit, target current, pin temperature, and/or the like), and/or vehicle attributes (e.g., model type, ownership type, mileage, and/or the like). As described in more detail below with respect to FIG. 4, training of such a machine learning model may involve a supervised learning process that is based on labeled training data generated using past vehicle charge records, such as indicating past charge times associated with sets of attributes. The machine learning model may be, for example, a gradient boosted tree model or another suitable type of machine learning model.

In some embodiments, a physics based algorithm (e.g., involving a lookup table that stores associations between sets of attributes and expected charge times) is run in combination (e.g., in parallel) with machine learning based techniques described herein, and both techniques are used as part of a process for determining a charge time estimate. For example, an arbitration component may evaluate outputs from a machine learning based technique and a physics based technique, such as based on confidence levels associated with one or more of the outputs, in order to determine which output(s) to use for a charge time estimate. Furthermore, in cases where a machine learning based technique cannot be performed (e.g., due to connectivity issues and/or other resource constraints), a physics based algorithm may be used.

Machine learning based techniques described herein for vehicle charge time estimation have a number of technical benefits. For example, by employing historical vehicle charge data to inform a machine learning model, aspects of the present disclosure capture diverse charging behaviors and vehicle usage patterns in a dynamic automated charge time estimation process. Additionally, by introducing segmented prediction through generation of charge time predictions for each of multiple intervals between a current charge level and a complete charge level, techniques described herein dissect the charging process into manageable segments that are tailored to the complexity of electric vehicle charging dynamics for more accurate and informative predictions. For example, generating incremental charge time predictions rather than a single prediction for a complete charge allows a user to be provided with more granular and accurate information to assist in targeted decision-making, and reduces computing resource utilization by allowing a single set of outputs from the machine learning model to be used to provide multiple charge time estimates, even if the user submits an updated estimate request with a different target charge level. Generally, according to techniques described herein, comprehensive input dimensions for a machine learning model are meticulously integrated, including vehicle attributes, environmental factors, user behaviors, battery states, and/or charging infrastructure details, ensuring a well-rounded, highly adaptive prediction model that produces accurate results at a useful level of granularity.

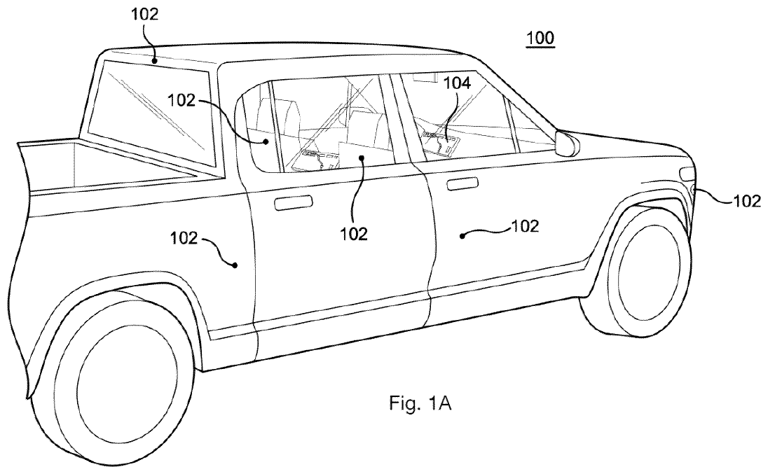

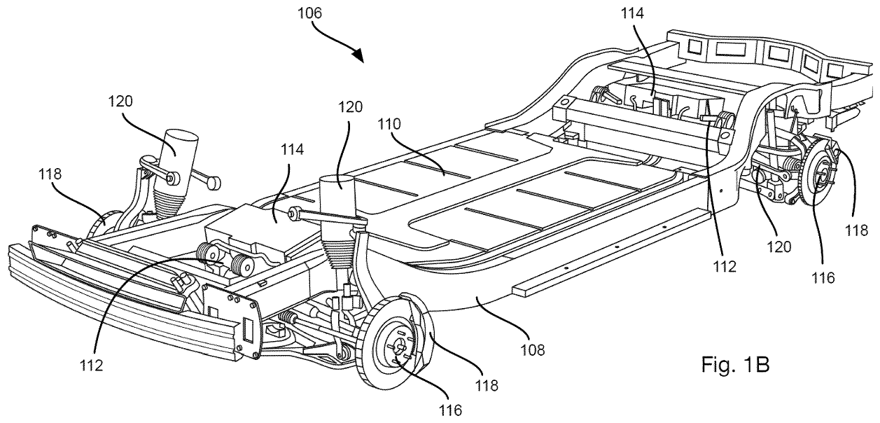

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

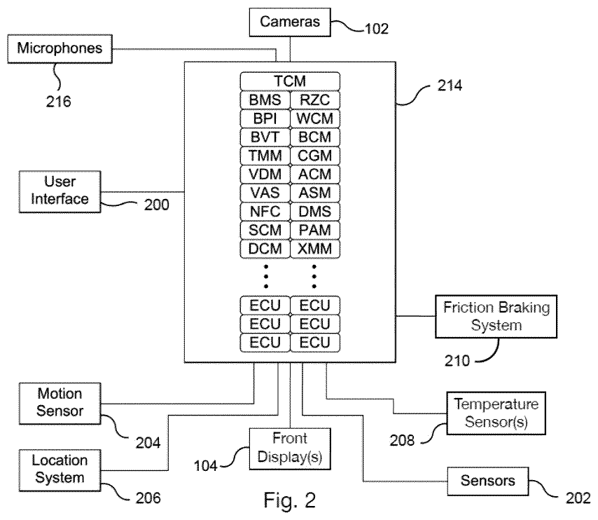

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 5. In certain embodiments, each of the ECUs is dedicated to a specific set of functions. Each ECU may be a computer system and each ECU may include functionality described below in relation to FIGS. 3 to 5.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfers data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described in relation to FIGS. 3 to 5.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

FIG. 3 presents a block diagram 300 representing example functionality related to electric vehicle charge time prediction through machine learning, in accordance with embodiments of the present disclosure.

In the example depicted in block diagram 300, a model request 382 from a computing system 301 of a vehicle triggers artificial intelligence (AI)/machine learning (ML) model functionality 350, involving providing input data 360 to a machine learning model 370 and receiving segmented predictions 372 as outputs from the machine learning model 370 in response to the input data 360. Machine learning model 370 may, for example, have been trained through a supervised learning process such as that described below with respect to FIG. 4.

Model request 382 may be initiated as a result of input received via one or more vehicle controls 302 of computing system 301, which may be associated with a user interface of the vehicle. For example, a user may interact with vehicle controls 302 in order to request a charge time estimate for charging the battery of the vehicle via a particular vehicle charger, and model request 382 may be generated based on the user's request. In some embodiments, AI/ML model functionality 350 represents functionality provided by a remote computing device, such as a server that is remote from computing system 301 and connected to computing system 302 via a network (e.g., the Internet or any connection over which data may be transmitted).

Furthermore, an edge compute component 304 of computing system 301 may transmit edge computed signals 310 for use in AI/ML model functionality 350. For example, edge compute component 304 may receive and/or process data (e.g., from sensors and/or other components associated with the vehicle and/or one or more vehicle chargers) related to the vehicle, the vehicle's battery, and/or one or more vehicle chargers, including attributes such as present battery charge level, battery voltage, battery current, battery temperature, battery state of health, vehicle model type, vehicle ownership type, vehicle mileage, charger current limit, charger target current, charger pin temperature, and/or the like (e.g., such attributes may be sent as edge computed signals 310). In one example, a user specifies a vehicle charger, and edge compute component 304 retrieves attributes of the specified vehicle charger (e.g., from a remote computing device, a database, a cloud service, the charger itself, and/or the like). In some embodiments, the user also specifies a target charge level for the battery.

At AI/ML model functionality 350, data 360 (e.g., which may comprise edge computed signals 310 and/or values that are based on edge computed signals 310) is used to provide inputs to ML model 370. Data 360, for example, may include user/vehicle attributes (e.g., model type, ownership type, odometer or mileage data, and/or the like), battery attributes 364 (e.g., voltage, current, temperature, state of health, and/or the like), charger attributes 366 (e.g., electric vehicle supply equipment (EVSE) current limit, target current, pin temperature, and/or the like), and/or one or more other attributes. Data 360 may be generated based on edge computed signals and/or additional processing such as feature engineering (e.g., edge computed signals 310 may be processed to generate one or more of the attributes in data 360). The attributes in data 360 may be provided as inputs to ML model 370, and ML model 370 may output segmented predictions 372 in response.

ML model 370 may be any suitable type of machine learning model, such as a neural network, a tree-based model, a regression model, and/or the like. In one particular embodiment, ML model 370 is a gradient boosted tree model. In another particular example, ML model 370 is a random forest model

A tree-based model (e.g., a decision tree) generally makes a classification by dividing inputs into smaller classifications at nodes, resulting in an ultimate classification at a leaf. Gradient boosting is a method for optimizing tree models, and generally involves building a model of trees in a stage-wise fashion, optimizing an arbitrary differentiable loss function. For example, gradient boosting may involve combining weak “learners” into a single strong learner in an iterative fashion. A weak learner generally refers to a classifier that chooses a threshold for one feature and splits the data on that threshold, is trained on that specific feature, and generally is only slightly correlated with the true classification (e.g., being at least more accurate than random guessing). A strong learner is a classifier that is arbitrarily well-correlated with the true classification, which may be achieved through a process that combines multiple weak learners in a manner that optimizes an arbitrary differentiable loss function. The process for generating a strong learner may involve a majority vote of weak learners. Examples of boosted tree models include XGBoost and LightGBM. LightGBM, for example, is a tree-based ML algorithm that leverages gradient boosting frameworks to process large datasets. It is designed for speed and efficiency, enabling it to handle complex data with higher accuracy and reduced computational time. A random forest extends the concept of a decision tree model, except the nodes included in any given decision tree within the forest are selected with some randomness. Thus, random forests may reduce bias and group outcomes based upon the most likely positive responses.

Segmented predictions 372 generally include charge time predictions for each of a plurality of intervals between a current charge level of the battery and a complete charge level. For example, the intervals may correspond to a particular percentage such as five percent state of charge (SOC) intervals. In one particular example, the current charge level is 70% and segmented predictions 372 include predicted amounts of time to charge to 75% (e.g., from 70%), to 80% (e.g., from 75%), to 85% (e.g., from 80%), to 90% (e.g., from 85%), to 95% (e.g., from 90%), and to 100% (e.g., from 95%).

Prediction results 312 may be provided back to computing system 301, such as indicating segmented predictions 372 (e.g., associated with one or more confidence scores that are output by ML model 370 in association with segmented predictions 372).

An electric vehicle energy management system (EMS) arbitrator may utilize segmented predictions 372 (e.g., which it may receive via prediction results 312) and/or results of processing by an in-vehicle physics model 306 in order to determine a charge time estimate to provide to the user, such as via a user interface. In-vehicle physics model 306 generally represents a technique for predicting charge times based on configured associations between attributes and charge time estimates, such as in the form of a lookup table. For example, in-vehicle physics model 306 may run locally in the vehicle's computing system 301, and may be based on physical properties of batteries. In-vehicle physics model 306 may serve as a fallback method of determining charge time estimates in cases where AI/ML model functionality 350 is not available (e.g., due to a lack of connectivity between computing system 301 and a computing device on which AI/ML model functionality 350 is implemented and/or otherwise due to resource constraints), in cases where ML model 370 produces predictions with low confidence scores, and/or the like. EMS arbitrator 307 may serve as an arbitrator between a charge time estimate generated using in-vehicle physics model 306 (e.g., based on parameters determined via edge compute component 304) and prediction results 312. For example, EMS arbitrator 308 may use prediction results 312 for a charge time estimate if prediction results 312 are associated with one or more confidence scores above a threshold, and may use a charge time estimate generated using in-vehicle physics model 306 if prediction results 312 are associated with one or more confidence scores below the threshold. In some cases, EMS arbitrator 308 may use a combination of prediction results 312 and a charge time estimate generated using in-vehicle physics model 306 for a charge time estimate, such as using the results of one technique as an upper and/or lower bound for the results of the other technique.

In some embodiments, prediction results 312 are used to generate a charge time estimate based on a request from the user. For example, if the user requests a charge time estimate for a particular target charge amount, one or more of segmented predictions 372 may be used to generate the charge time estimate. In a particular example, the current charge level is 70%, segmented predictions 372 include charge time predictions for each 5% increment between 70% and 100%, and the user requested a charge time estimate for charging to 90%. In such an example, the charge time estimate may be determined by adding the segmented predictions 372 for the increments between the current charge level and the target charge level, which in this case would be the charge time estimates for charging to 75%, 80%, 85%, and 90%. If the user then submitted a subsequent request for a charge time estimate for charging to a different charge level, such as 85%, a charge time estimate could be generated for the subsequent request without submitting a new request to the model. For example, the charge time estimate for the subsequent request could be determined by adding the segmented predictions 372 for the increments between the current charge level and the target charge level indicated in the subsequent request, which in this case would be the charge time estimates for charging to 75%, 80%, and 85%. If the target charge level indicated in a user request does not directly correspond to the increments for which segmented predictions 372 are generated, such as a target charge level of 83%, then the charge time estimate may be determined based on a fraction of at least one of the segmented predictions 372 (e.g., assuming a constant charge speed during each 5% increment). In such an example, the charge time estimate may be determined by adding the segmented predictions 372 for the increments between the current charge level and the target charge level while using a fraction of one or the segmented predictions 372, such as adding the charge time estimates for charging to 75% and 80% and ⅗ of the charge time estimate for charging to 85%. It is noted that these numbers and computations are included as examples, and other embodiments are possible. In another example, the charge time estimate for a charge level of 83% is calculated using the formula (83−80)/(predicted value).

Segmented prediction feedback 384 generally represents displaying a charge time estimate via a user interface based on segmented prediction 372. For example, in some embodiments a charge time estimate is displayed via a user interface, such as on an infotainment screen in the vehicle, via a mobile application, and/or the like. The charge time estimate may be a single predicted amount of time to reach a target level of charge and/or may include multiple iterative charge time predictions, such as corresponding to segmented predictions 372 (e.g., the user may be provided with an estimated amount of time to charge to each of multiple iterative charge levels). In other embodiments, a displayed charge time estimate is based on an output of in-vehicle physics model 306.

A charge time generated and displayed as a result of techniques described herein may have a high level of accuracy due to dynamic machine learning techniques that take into consideration a variety of attributes of the battery, the vehicle, and/or the vehicle charger. Furthermore, multiple charge time estimates may be efficiently generated based on a single model request due to the multiple iterative predictions output by the model.

FIG. 4 presents a block diagram 400 of example functionality related to training a machine learning model for electric vehicle charge time prediction, in accordance with embodiments of the present disclosure. For example, block diagram 400 may represent a supervised learning process by which machine learning model 370 of FIG. 3 may be trained.

Training data 410 may be used to train machine learning model 370. For example, training data 410 may include parameters 412 associated with labels 414, such as indicating past charge time associated with parameters 412. In an example, a training data instance may include a set of parameters (e.g., vehicle battery parameters, vehicle parameters, and/or vehicle charger parameters) and one or more charge times that were historically associated with that set of parameters, such as durations of time required to charge a battery associated with the set of parameters to each of a plurality of iterative charge levels (e.g., 5% increments or another size of increments from a current or starting charge level to a complete charge level). Training data 410 may be based on records of past vehicle battery charges for one or more vehicles.

Supervised learning generally involves providing training inputs (e.g., parameters 412) as inputs to machine learning model 370. Machine learning model 370 may process the training inputs and produce outputs (e.g., predicted charge times 422) based on the training inputs. For example, an output layer of machine learning model 370 may be configured to output predicted charge times 422, which may include a set of incremental charge time predictions (e.g., between a current or starting charge level and a complete charge level) for each set of parameters within parameters 412. At evaluate predictions based on labels and update model parameters 430, the outputs may be compared to the labels (e.g., labels 414) associated with the training inputs in training data 410 to determine the accuracy of the model, and parameters of machine learning model 370 may be adjusted (e.g., iteratively over a series of training iterations) until one or more conditions are met. For instance, the one or more conditions may relate to a loss function or cost function for optimizing one or more variables (e.g., relating to model accuracy, recall, and/or the like). In some embodiments, the conditions may relate to whether the predictions produced by the model based on the training inputs match the labels associated with the training inputs or whether a measure of error between training iterations is not decreasing or not decreasing more than a threshold amount. The conditions may also include whether a training iteration limit has been reached. Parameters of machine learning model 370 adjusted during training may include, for example, hyperparameters, values related to numbers of iterations, weights, functions used by nodes to calculate scores, and the like. In some embodiments, validation and testing are also performed for machine learning model 370, such as based on validation data and test data, as is known in the art.

In some embodiments, machine learning model 370 may be retrained over time based on updated training data as vehicle charges are performed, producing an interactive feedback loop. For example, as ground truth data becomes available indicating amounts of time taken to charge vehicle batteries to each of a plurality of increments, such as using particular vehicle chargers, the attributes associated with such instances of charging vehicle batteries may be associated with such charge times to create updated training data 410. Retraining of machine learning model 370 may be substantively similar to the process described with respect to block diagram 400. For example, after the trained machine learning model 370 is used to determine charge time predictions for a particular set of attributes, ground truth data may be received for how long it actually took to charge the battery associated with the particular set of attributes, and the ground truth data may be used to generated updated training data that is used to retrain machine learning model 370, and the retrained machine learning model 370 may be used to generate subsequent charge time predictions with a higher level of accuracy.

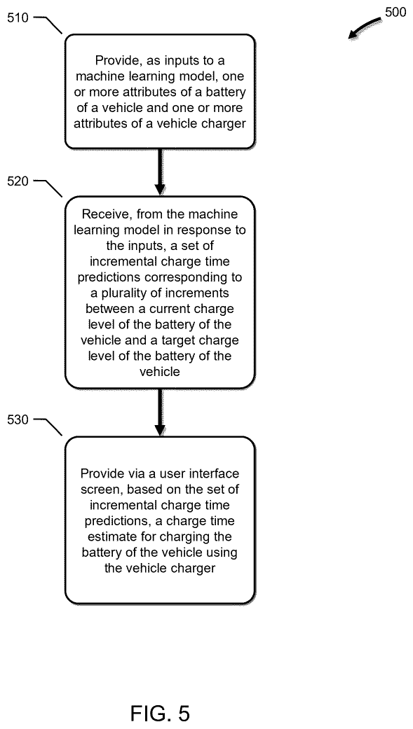

FIG. 5 depicts a method 500 representing functionality associated with electric vehicle charge time prediction, in accordance with embodiments of the present disclosure. For example, flow chart 500 may represent functionality that is performed by one or more components described above with respect to FIGS. 1A-4, such as one or more ECUs of control system 214 of FIG. 2 and/or one or more associated components (either local or remote).

The method 500 may include providing, at 510, as inputs to a machine learning model, one or more attributes of a battery of a vehicle and one or more attributes of a vehicle charger.

In some embodiments, the machine learning model has been trained through a supervised learning process based on past incremental charge times associated with particular attributes. In certain embodiments, the machine learning model comprises a gradient boosted tree model.

In some embodiments, the one or more attributes of the battery of the vehicle comprise one or more of: a voltage; a current; a temperature; or a state of health. It is noted that these attributes are included as examples, and other attributes of the battery of the vehicle may be used with techniques described herein.

In certain embodiments, the one or more attributes of the vehicle charger comprise one or more of: a current limit; a target current; or a pin temperature. It is noted that these attributes are included as examples, and other attributes of the vehicle charger may be used with techniques described herein.

In some embodiments, the inputs provided to the machine learning model further comprise one or more attributes of the vehicle. For example, the one or more attributes of the vehicle may comprise one or more of: a model type; an ownership type; or a mileage.

The method 500 may include receiving, at 520, from the machine learning model in response to the inputs, a set of incremental charge time predictions corresponding to a plurality of increments between a current charge level of the battery of the vehicle and a target charge level of the battery of the vehicle.

The method 500 may include providing, at 530, via a user interface screen, based on the set of incremental charge time predictions, a charge time estimate for charging the battery of the vehicle using the vehicle charger.

In some embodiments, the charge time estimate is provided based on a first charge time estimate request relating to a first target charge amount, and wherein the method further comprises providing, via the user interface screen, based on the set of incremental charge time predictions, an updated charge time estimate based on a second charge time estimate request relating to a second target charge amount that is different than the first target charge amount. For example, the machine learning model may not need to be used again to determine the updated charge time estimate, as the set of incremental charge time predictions previously output by the machine learning model already includes information that can be used to determine the updated charge time estimate relating to the second target charge amount.

Certain embodiments further comprise determining an alternate charge time prediction using a physics-based algorithm based on the one or more attributes of the battery of the vehicle and the one or more attributes of the vehicle charger, wherein the providing of the charge time estimate is further based on the alternate charge time prediction.

Some embodiments further comprise determining to use the set of incremental charge time predictions rather than the alternate charge time prediction for determining the charge time estimate based on a confidence level associated with the set of incremental charge time predictions.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method for electric vehicle charge time prediction, comprising:
providing, as inputs to a machine learning model, one or more attributes of a battery of a vehicle and one or more attributes of a vehicle charger;
receiving, from the machine learning model in response to the inputs, a set of incremental charge time predictions corresponding to a plurality of increments between a current charge level of the battery of the vehicle and a target charge level of the battery of the vehicle; and
providing via a user interface screen, based on the set of incremental charge time predictions, a charge time estimate for charging the battery of the vehicle using the vehicle charger.

2. The method of claim 1, wherein the machine learning model has been trained through a supervised learning process based on past incremental charge times associated with particular attributes.

3. The method of claim 1, wherein the machine learning model comprises a gradient boosted tree model.

4. The method of claim 1, wherein the one or more attributes of the battery of the vehicle comprise one or more of: a voltage; a current; a temperature; or a state of health.

5. The method of claim 1, wherein the one or more attributes of the vehicle charger comprise one or more of: a current limit; a target current; or a pin temperature.

6. The method of claim 1, wherein the inputs provided to the machine learning model further comprise one or more attributes of the vehicle.

7. The method of claim 6, wherein the one or more attributes of the vehicle comprise one or more of: a model type; an ownership type; or a mileage.

8. The method of claim 1, wherein the charge time estimate is provided based on a first charge time estimate request relating to a first target charge amount, and wherein the method further comprises providing, via the user interface screen, based on the set of incremental charge time predictions, an updated charge time estimate based on a second charge time estimate request relating to a second target charge amount that is different than the first target charge amount.

9. The method of claim 1, further comprising determining an alternate charge time prediction using a physics-based algorithm based on the one or more attributes of the battery of the vehicle and the one or more attributes of the vehicle charger, wherein the providing of the charge time estimate is further based on the alternate charge time prediction.

10. The method of claim 9, further comprising determining to use the set of incremental charge time predictions rather than the alternate charge time prediction for determining the charge time estimate based on a confidence level associated with the set of incremental charge time predictions.

11. A vehicle comprising:
one or more processors; and
a memory storing instructions that, when executed by the one or more processors, cause the one or more processors to:
provide, as inputs to a machine learning model, one or more attributes of a battery of a vehicle and one or more attributes of a vehicle charger;
receive, from the machine learning model in response to the inputs, a set of incremental charge time predictions corresponding to a plurality of increments between a current charge level of the battery of the vehicle and a target charge level of the battery of the vehicle; and
provide via a user interface screen, based on the set of incremental charge time predictions, a charge time estimate for charging the battery of the vehicle using the vehicle charger.

12. The vehicle of claim 11, wherein the machine learning model has been trained through a supervised learning process based on past incremental charge times associated with particular attributes.

13. The vehicle of claim 11, wherein the machine learning model comprises a gradient boosted tree model.

14. The vehicle of claim 11, wherein the one or more attributes of the battery of the vehicle comprise one or more of: a voltage; a current; a temperature; or a state of health.

15. The vehicle of claim 11, wherein the one or more attributes of the vehicle charger comprise one or more of: a current limit; a target current; or a pin temperature.

16. The vehicle of claim 11, wherein the inputs provided to the machine learning model further comprise one or more attributes of the vehicle.

17. The vehicle of claim 16, wherein the one or more attributes of the vehicle comprise one or more of: a model type; an ownership type; or a mileage.

18. The vehicle of claim 11, wherein the charge time estimate is provided based on a first charge time estimate request relating to a first target charge amount, and wherein the instructions, when executed by the one or more processors, further cause the one or more processors to provide, via the user interface screen, based on the set of incremental charge time predictions, an updated charge time estimate based on a second charge time estimate request relating to a second target charge amount that is different than the first target charge amount.

19. The vehicle of claim 11, wherein the instructions, when executed by the one or more processors, further cause the one or more processors to determine an alternate charge time prediction using a physics-based algorithm based on the one or more attributes of the battery of the vehicle and the one or more attributes of the vehicle charger, wherein the providing of the charge time estimate is further based on the alternate charge time prediction.

20. A non-transitory computer readable medium comprising instructions that, when executed by one or more processors of a computing system, cause the computing system to:
provide, as inputs to a machine learning model, one or more attributes of a battery of a vehicle and one or more attributes of a vehicle charger;
receive, from the machine learning model in response to the inputs, a set of incremental charge time predictions corresponding to a plurality of increments between a current charge level of the battery of the vehicle and a target charge level of the battery of the vehicle; and
provide via a user interface screen, based on the set of incremental charge time predictions, a charge time estimate for charging the battery of the vehicle using the vehicle charger.
